(19) United States
(12) Patent Application Publication
(10) Pub. No.: US 2023/0214645 A1
(43) Pub. Date: Jul. 6, 2023

(54) LEARNING APPARATUS, LEARNING SYSTEM, AND LEARNING METHOD

(71) Applicant: KABUSHIKI KAISHA TOSHIBA, Tokyo (JP)

(72) Inventors: Chenyuan Xu, Kawasaki Kanagawa (JP); Kosuke Haruki, Tachikawa Tokyo (JP); Masahiro Ozawa, Yokohama Kanagawa (JP); Ryuji Sakai, Hanno Saitama (JP); Kazuki Uematsu, Fuchu Tokyo (JP)

(73) Assignee: KABUSHIKI KAISHA TOSHIBA, Tokyo (JP)

(21) Appl. No.: 17/823,913

(22) Filed: Aug. 31, 2022

(30) Foreign Application Priority Data
Jan. 4, 2022 (JP) 2022-000215

(51) Int. Cl. G06N 3/08; G06K 9/62

(52) U.S. Cl. CPC G06N 3/08; G06K 9/6256; G06K 9/6265

(57) ABSTRACT

According to one embodiment, a learning apparatus includes processing circuitry. The processing circuitry generates a plurality of pieces of partial data from a mini-batch of learning data used for a plurality of learning processes for learning of a parameter of a neural network using an objective function, calculates a partial gradient that is a gradient related to the parameter of the objective function for each of the pieces of partial data, and updates the parameter based on an average value of the plurality of partial gradients corresponding to the pieces of partial data and a variance for the partial gradients.

### CROSS-REFERENCE TO RELATED APPLICATIONS

This application is based upon and claims the benefit of priority from Japanese Patent Application No. 2022-000215, filed Jan. 4, 2022, the entire contents of which are incorporated herein by reference.

### FIELD

Embodiments described herein relate generally to a learning apparatus, a learning system, and a learning method.

### BACKGROUND

There has been conventionally known a method for deep learning that is a sort of machine learning by which to perform parallel learning using a plurality of processors or multi-core processors, or a plurality of devices. Using parallel learning has an advantage that the learning processing can be speeded up by the number of parallel processes. On the other hand, parallel learning has a problem that the learning effect decreases when the data size (batch size) used for one update increases.

### BRIEF DESCRIPTION OF THE DRAWINGS

FIG. 1 is a block diagram illustrating a configuration of an information processing system including a learning apparatus according to a first embodiment.

FIG. 2 is a flowchart of a parameter update process in the first embodiment.

FIG. 3 is a flowchart illustrating a specific example of the parameter update process in the first embodiment.

FIG. 4 is a flowchart of a parameter update process in a second embodiment.

FIG. 5 is a flowchart of a partial gradient calculation process in the flowchart of FIG. 4.

FIG. 6 is a flowchart illustrating a specific example of the parameter update process in the second embodiment.

FIG. 7 is a block diagram illustrating a configuration example of an information processing system including a management apparatus and a plurality of learning apparatuses in a third embodiment.

FIG. 8 is a flowchart illustrating a specific example of a parameter update process in the third embodiment.

FIG. 9 is a diagram illustrating a ring All-Reduce communication pattern in the third embodiment.

FIG. 10 is a diagram illustrating a specific example in which nodes share an average value of a plurality of partial gradients in the ring All-Reduce illustrated in FIG. 3.

FIG. 11 is a diagram illustrating a specific example in which the nodes share a variance of a plurality of partial gradients in the ring All-Reduce illustrated in FIG. 3.

FIG. 12 is a diagram illustrating a specific example in which the nodes simultaneously share an average value and a variance in the ring All-Reduce illustrated in FIG. 3.

FIG. 13 illustrates evaluation results including learning curves using the parameter update processes in the first embodiment to the third embodiment.

FIG. 14 is a flowchart illustrating a specific example of a parameter update process in a fourth embodiment.

FIG. 15 illustrates evaluation results including learning curves using the parameter update process in the fourth embodiment.

FIG. 16 is a block diagram illustrating a hardware configuration of a computer according to an embodiment.

### DETAILED DESCRIPTION

In general, according to one embodiment, a learning apparatus includes processing circuitry. The processing circuitry generates a plurality of pieces of partial data from a mini-batch of learning data used for a plurality of learning processes for learning of a parameter of a neural network using an objective function, calculates a partial gradient that is a gradient related to the parameter of the objective function for each of the pieces of partial data, and updates the parameter based on an average value of the plurality of partial gradients corresponding to the pieces of partial data and a variance for the partial gradients.

First, an outline of machine learning used in each embodiment will be described. In deep learning, which is a sort of machine learning, optimization is performed by stochastic gradient descent (SOD) generally using mini-batches. In addition, it is also known that when parameters for a neural network are updated using this SOD, optimization is performed by Momentum SOD in consideration of a momentum term. In relation to the following embodiments, optimization using Momentum SOD (that is, parameter update) will be described. However, other optimization methods such as SOD and Nesterov acceleration method may be used.

First, as optimization by SOD, it is considered that a neural network using an objective function f and a parameter w is used to perform parameter updates. For learning data xₜ used for the t-th parameter update, a gradient gₜ of a parameter wₜ is expressed by the following formula (1).

gₜ=∇f(xₜ;wₜ) (1)

The t+1th parameter wₜ₊₁ using the gradient gₜ and the learning coefficient in is expressed by the following formula (2).

wₜ₊₁=wₜ−η·gₜ (2)

In the optimization by Momentum SGD, a momentum term vₜ expressed by the following formula (3) is used for parameter update.

vₜ=β·vₜ₋₁−η·gₜ (3)

In the formula (3), β represents a momentum coefficient. In the following embodiments, β=0.9 is set. When t=0, it is assumed that the momentum term vₜ=0.

The t+1th parameter wₜ₊₁ using the momentum term vₜ is expressed by the following formula (4).

wₜ₊₁=wₜ+vₜ (4)

The learning coefficient η of the above formula (3) may be changed during the learning. For example, under the conditions of the evaluation results described later, in the case of batch size 8192, the learning coefficient η is set to be gradually increased from 0 to 6.4 in the first 10 epochs, to be attenuated to 0.64 after reaching 80 epochs, and to be further attenuated to 0.064 after reaching 120 epochs.

Next, a partial gradient and an overall gradient which are gradients related to parameters of the objective function will be described. In the following embodiments, all data used in learning will be referred to as learning data, data used in one parameter update will be referred to as a mini-batch, and data processed by one processor or one device at a time will be referred to as partial data. The partial gradient is a gradient calculated for the partial data, and the overall gradient is a gradient calculated for the entire mini-batch.

For example, in the case of dividing a mini-batch xₜ used in the t-th update into partial data xₜⁿ (where n>2), a partial gradient gen calculated using partial data xₜⁿ is expressed by the following formula (5).

gₜⁿ=∇f(xₜⁿ;wₜ) (5)

The overall gradient gₜ is expressed by the following formula (6) as an average value of the partial gradients gₜⁿ.

$${g}_{t} = \overline{{g}_{t}} = \frac{1}{n} \sum {g}_{t}^{n} \qquad ( 6 )$$

Hereinafter, embodiments of a learning apparatus and a learning system will be described in detail with reference to the drawings.

### First Embodiment

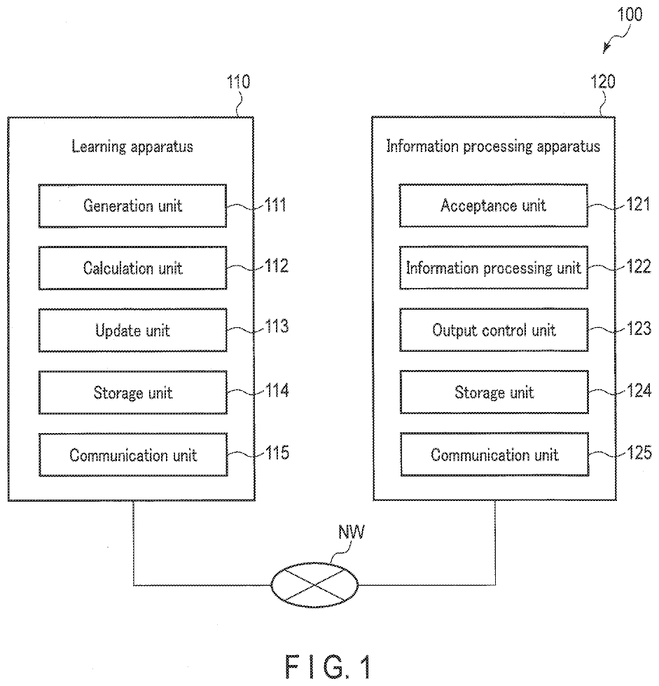

FIG. 1 is a block diagram illustrating a configuration of an information processing system 100 including a learning apparatus 110 according to a first embodiment. The information processing system 100 illustrated in FIG. 1 includes the learning apparatus 110 and an information processing apparatus 120. The learning apparatus 110 and the information processing apparatus 120 are connected via, for example, a network NW. The network NW may be in any form such as a wired network, a wireless network, or the Internet. At least one of the learning apparatus 110 and the information processing apparatus 120 may be realized by, for example, a server apparatus which is a computer including a processor such as a central processing unit (CPU). Furthermore, the server apparatus may be a cloud server that executes processing on a cloud.

The learning apparatus 110 is an apparatus that trains a neural network. The information processing apparatus 120 is an apparatus that executes processes (for example, recognition process and classification process) using a neural network trained by the learning apparatus 110 or the like.

The learning apparatus 110 and the information processing apparatus 120 may not be separate apparatuses. For example, the learning apparatus 110 may have the functions of the information processing apparatus 120.

The learning apparatus 110 includes a generation unit 111, a calculation unit 112, an update unit 113, a storage unit 114 (memory), and a communication unit 115.

The generation unit 111 generates individual learning data used for learning of the neural network. Specifically, the generation unit 111 generates a plurality of mini-batches partially sampled from the learning data. The generation unit 111 also selects a mini-batch to be subjected to the learning process from the plurality of mini-batches, and generates a plurality of pieces of partial data from the selected mini-batch. If the amount of learning data is small, it is not necessary to generate a plurality of mini-batches, and thus the generation unit 111 may generate a plurality of pieces of partial data from the learning data.

The calculation unit 112 calculates various types of information used at the time of parameter learning in the neural network. Specifically, the calculation unit 112 calculates the gradient related to the parameters of an objective function for each of the plurality of pieces of partial data. As described above, hereinafter, the gradient calculated for the partial data will be referred to as a partial gradient. The calculation unit 112 also calculates the gradient for the entire mini-batch using a plurality of partial gradients. As described above, hereinafter, the gradient calculated for the entire mini-batch will be referred to as an overall gradient.

More specifically, the calculation unit 112 calculates an average value of the plurality of partial gradients and a variance for the plurality of partial gradients. The variance σ²(gₜ) for the plurality of partial gradients is expressed by the following formula (7) using the average value of the partial gradients gₜⁿ in the above formula (6).

$${σ}^{2} ( {g}_{t} ) = ( \frac{1}{n} {\sum }_{j = 1}^{n} {( {g}_{t}^{j} )}^{2} ) - {( \overline{{g}_{t}} )}^{2} \qquad ( 7 )$$

In the above formula (7), the square of the partial gradients is calculated on the right side, but the present invention is not limited thereto. For example, at calculation of the variance σ²(gₜ), a deviation between the partial gradients and the average value of the partial gradients may be calculated.

Furthermore, the calculation unit 112 calculates the overall gradient using the average value and the variance. The overall gradient gₜ in the first embodiment using the average value and the variance is expressed by the following formula (8), unlike the conventional overall gradient gₜ expressed by the above formula (6).

$${g}_{t} = \overline{{g}_{t}} \cdot ( \frac{1}{\sqrt{{σ}^{2} ( {g}_{t} ) + {( \overline{{g}_{t}} )}^{2}}} ) \qquad ( 8 )$$

In other words, in the formula (8), the overall gradient is calculated by the product of the reciprocal of square root of sum of square of the average value and the variance and the average value.

The calculation unit 112 may include a multi-core processor or may include a plurality of processors. That is, the calculation unit 112 is configured to perform parallel processing in the above calculation.

The update unit 113 updates the parameters (weights) using the results of calculation by the calculation unit 112. The parameters to be updated may be any information. For example, in the case of neural network learning, a weight, a bias, and the like of the neural network are parameters. Hereinafter, a case of using mainly a weight as a parameter will be described as an example. The weight of the neural network may be rephrased as a coefficient (model coefficient) of a network model (also simply referred to as a model).

Specifically, the update unit 113 updates the weight using the average value and the variance. More specifically, the update unit 113 updates the weight using the overall gradient calculated using the average value and the variance. The update unit 113 may determine whether to end the learning.

The storage unit 114 stores various types of information used in various processes by the learning apparatus 110. Specifically, the storage unit 114 stores parameters of the neural network to be learned, learning data used for learning of the neural network, and the like.

The communication unit 115 communicates with the information processing apparatus 120 for various types of information provided by the learning apparatus 110. Specifically, the communication unit 115 receives the learning data from the information processing apparatus 120. The communication unit 115 also transmits (outputs) the parameters of the trained neural network to the information processing apparatus 120.

The information processing apparatus 120 includes an acceptance unit 121, an information processing unit 122, an output control unit 123, a storage unit 124 (memory), and a communication unit 125.

The acceptance unit 121 accepts inputs of various types of information used in various processes by the information processing apparatus 120. Specifically, the acceptance unit 121 accepts the parameters of the neural network output from the learning apparatus 110.

The information processing unit 122 executes information processing using a neural network. The information processing includes, for example, an image recognition process and an image classification process using a neural network. The information processing is not limited thereto, and may include any process using a neural network. For example, the information processing may include a recognition process and a classification process for data other than images (for example, text and sound).

The output control unit 123 controls output of various types of information by the information processing apparatus 120. Specifically, the output control unit 123 controls output of the learning data to the learning apparatus 110 and output of information on an instruction to start learning or information on an instruction to end learning to the learning apparatus 110.

The storage unit 124 stores various types of information used in various processes by the information processing apparatus 120. Specifically, the storage unit 124 stores the parameters of the neural network output from the learning apparatus 110.

The communication unit 125 communicates various types of information provided by the information processing apparatus 120 with the learning apparatus 110. Specifically, the communication unit 125 transmits the learning data to the learning apparatus 110. The communication unit 125 also receives the parameters of the trained neural network from the learning apparatus 110.

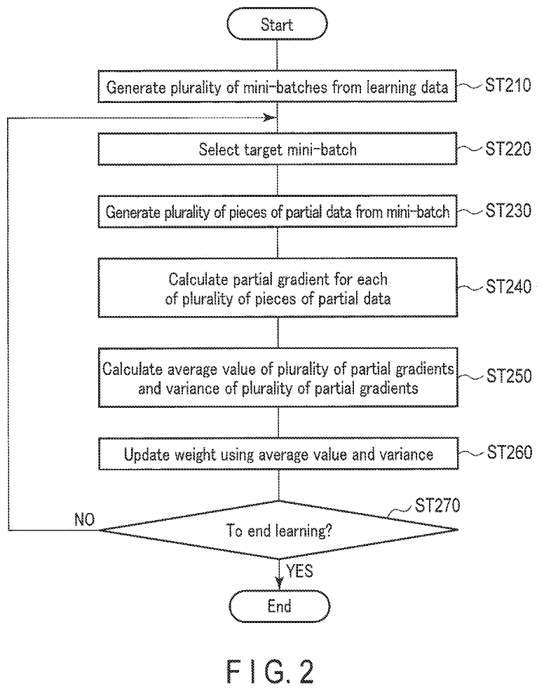

The configuration of the learning apparatus 110 and the like according to the first embodiment has been described above. Next, the operations of the learning apparatus 110 will be described with reference to the flowchart of FIG. 2.

FIG. 2 is a flowchart of a parameter update process in the first embodiment. The flowchart of FIG. 2 illustrates, for example, a flow of series of steps in which the learning apparatus 110 trains a neural network with learning data. The process in the flowchart of FIG. 2 starts when the learning apparatus 110 receives the learning data and a learning start instruction from the information processing apparatus 120.

### (Step ST210)

The generation unit 111 generates a plurality of mini-batches from the learning data.

### (Step ST220)

After generating the plurality of mini-batches, the generation unit 111 selects a target mini-batch to be subjected to the learning process from among the plurality of mini-batches.

### (Step ST230)

After selecting the target mini-batch, the generation unit 111 generates a plurality of pieces of partial data from the mini-batch.

### (Step ST240)

After generation of the plurality of pieces of partial data, the calculation unit 112 calculates a partial gradient for each of the plurality of pieces of partial data.

### (Step ST250)

After calculating the plurality of partial gradients, the calculation unit 112 calculates an average value of the plurality of partial gradients and a variance of the plurality of partial gradients.

### (Step ST260)

After calculation of the average value and the variance, the update unit 113 updates the weight using the average value and the variance.

### (Step ST270)

After updating the weight, the update unit 113 determines whether to end the learning. For example, the update unit 113 determines that the learning is to end when all of the plurality of mini-batches have been processed. If the update unit 113 determines that the learning is not to end, the process returns to step ST220. If the update unit 113 determines that the learning is to end, the process ends.

The flow of series of steps of training the neural network in the first embodiment has been described above. Next, a specific process performed with one parameter update in the first embodiment will be described.

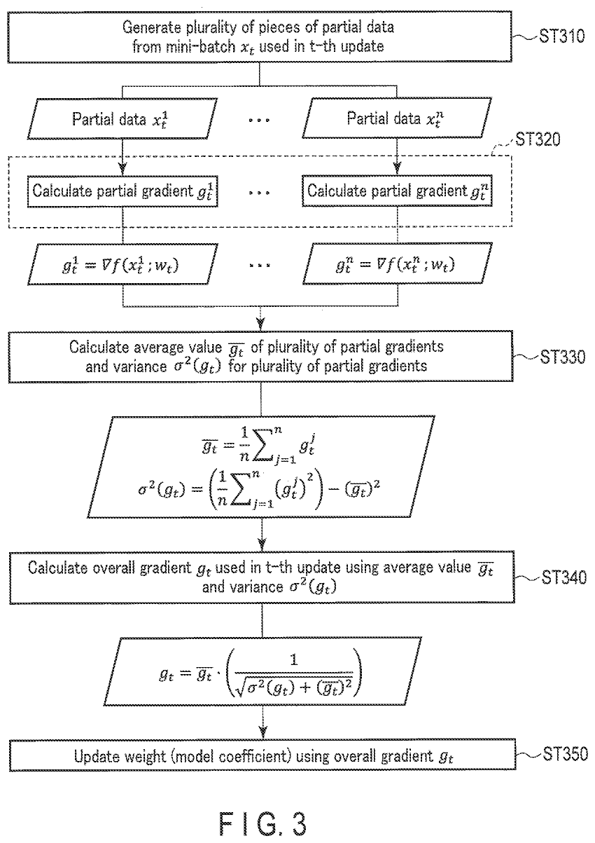

FIG. 3 is a flowchart illustrating a specific example of a parameter update process in the first embodiment. The flowchart of FIG. 3 relates to the process from step ST230 to step ST260 in the flowchart of FIG. 2. Hereinafter, specific processing of a mini-batch xₜ used in the t-th update will be described.

### (Step ST310)

The generation unit 111 generates a plurality of pieces of partial data from the mini-batch xₜ used in the t-th update. In the case of dividing the mini-batch xₜ into n pieces of partial data, the generation unit 111 generates partial data xₜ¹ to partial data xₜⁿ.

### (Step ST320)

The calculation unit 112 calculates a partial gradient for each of the plurality of pieces of partial data. For example, the calculation unit 112 calculates partial gradients gₜ¹ to gₜⁿ corresponding to the partial data xₜ¹ to the partial data xₜⁿ. The partial gradient gₜ¹ and the partial gradient gₜⁿ are expressed by the following formulas (9) and (10), respectively.

gₜ¹=∇f(xₜ¹;wₜ) (9)

gₜⁿ=∇f(xₜⁿ;wₜ) (10)

### (Step ST330)

The calculation unit 112 calculates an average value gₜ of the plurality of partial gradients (in FIG. 3, a horizontal bar indicating the average value is added above gₜ) and a variance σ²(gₜ) for the plurality of partial gradients. Hereinafter, the bar indicating the average value will be omitted in the specification. The average value gₜ and the variance σ²(gₜ) are expressed by the following formulas (11) and (12), respectively.

$$\overline{{g}_{t}} = \frac{1}{n} {\sum }_{j = 1}^{n} {g}_{t}^{j} \qquad ( 11 )$$

$${σ}^{2} ( {g}_{t} ) = ( \frac{1}{n} {\sum }_{j = 1}^{𝔫} {( {g}_{t}^{j} )}^{2} ) - {( \overline{{g}_{t}} )}^{2} \qquad ( 12 )$$

### (Step ST340)

The calculation unit 112 calculates an overall gradient gₜ used in the t-th update using the average value gₜ and the variance σ² (gₜ). The overall gradient gₜ is expressed by the following Formula (13).

$${g}_{t} = \overline{{g}_{t}} \cdot ( \frac{1}{\sqrt{{σ}^{2} ( {g}_{t} ) + {( \overline{{g}_{t}} )}^{2}}} ) \qquad ( 13 )$$

### (Step ST350)

The update unit 113 updates the weight (model coefficient) using the overall gradient gₜ. For example, in the case of optimization by Momentum SGD, the update unit 113 updates the weight by applying the formulas (3) and (4) described above.

As described above, the learning apparatus according to the first embodiment generates a plurality of pieces of partial data from a mini-batch of learning data used for a plurality of learning processes for learning of a parameter of a neural network using an objective function, calculates a partial gradient that is a gradient related to the parameter of the objective function for each of the plurality of pieces of partial data, and updates the parameter based on an average value of the plurality of partial gradients corresponding to the plurality of pieces of partial data and a variance for the plurality of partial gradients.

Therefore, the learning apparatus according to the first embodiment can realize efficient learning taking into consideration the variance component included in the parameter.

The learning apparatus also calculates the overall gradient that is a gradient of the objective function related to the mini-batch by using the average value and the variance, and updates the parameter based on the overall gradient. Furthermore, the learning apparatus calculates the overall gradient by the product of the reciprocal of square root of sum of square of the average value and the variance and the average value.

For example, the parameter includes a “component with large variance” and a “component with small variance”. Since the gradient itself is large in the “component with large variance”, the learning of this component is terminated early. Since the gradient itself is small in the “component with small variance”, it is considered that learning of this component is insufficient even at the end. From this aspect, if the “component with large variance” and the “component with small variance” are learned in the same update step (parameter update), the learning efficiency may be deteriorated.

In order to suppress the decrease in the learning efficiency, the learning apparatus according to the first embodiment uses the overall gradient including the reciprocal of the variance at the updating of the parameter to adjust the learning speeds of the “component with large variance” and the “component with small variance”, thereby providing improvement in the learning efficiency.

### Second Embodiment

In relation to the first embodiment, updating the weight using the average value and the variance has been described. On the other hand, in relation to a second embodiment, calculation of a partial gradient with a parameter to which noise is further added will be described.

A calculation unit 112 according to the second embodiment further calculates noise to be added to the parameter. Specifically, in the process of calculating a partial gradient gₜⁿ using the partial data xₜⁿ, the calculation unit 112 calculates the partial gradient gₜⁿ by adding noise θₜⁿ to a parameter wₜ. For example, the partial gradient gₜⁿ calculated by adding the noise θₜⁿ to the parameter wₜ is expressed by the following formula (14).

gₜⁿ=∇f(xₜⁿ;wₜ+θₜⁿ) (14)

The calculation unit 112 also calculates the noise θₜⁿ based on an earlier partial gradient (for example, the previous partial gradient). Specifically, the calculation unit 112 calculates the noise θₜⁿ by using a difference between the immediately preceding overall gradient gₜ₋₁ calculated by the immediately preceding parameter update and the immediately preceding partial gradient gₜ₋₁ⁿ of the immediately preceding partial data used at the time of the immediately preceding parameter update. The noise θₜⁿ is calculated by, for example, the following equation (15).

θₜⁿ=gₜ₋₁−gₜ₋₁ⁿ (15)

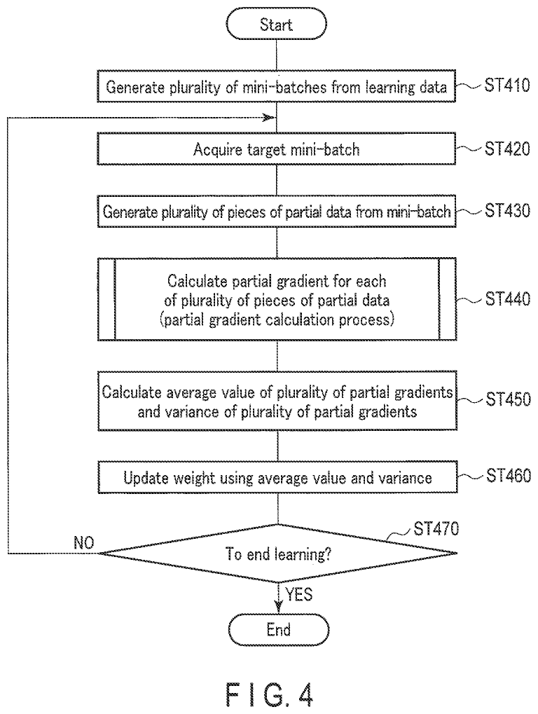

FIG. 4 is a flowchart of a parameter update process in the second embodiment. Steps in the flowchart of FIG. 4 are similar to steps in the flowchart of FIG. 2 except for some steps. Step ST440 in the flowchart of FIG. 4 is a subroutine, differently from step ST240 in the flowchart of FIG. 2. Therefore, only step ST440 will be described.

### (Step ST440)

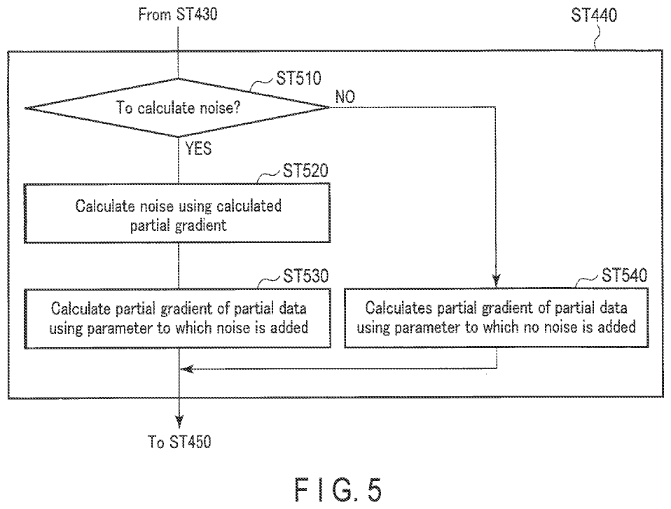

After generation of the plurality of pieces of partial data, the calculation unit 112 calculates a partial gradient for each of the plurality of pieces of partial data. In the second embodiment, the calculation unit 112 calculates a partial gradient for partial data using a parameter to which noise is added or a parameter to which no noise is added. Hereinafter, the process in step ST440 will be referred to as “partial gradient calculation process”. A specific example of the partial gradient calculation process will be described with reference to the flowchart of FIG. 5.

FIG. 5 is the flowchart of the partial gradient calculation process in the flowchart of FIG. 4. The flowchart of FIG. 5 is transitioned from step ST430.

### (Step ST510)

After generating a plurality of pieces of partial data, the calculation unit 112 determines whether to calculate noise in the current learning process. For example, the calculation unit 112 determines that no noise is to be calculated in any of sequential learning processes without the need for noise calculation, as in the first learning process or the like. If it is predetermined that noise is to be added in m-th and subsequent learning processes, the calculation unit 112 may determine that no noise is to be calculated in the first to (m−1)-th learning processes. If the calculation unit 112 determines that noise is to be calculated, the process proceeds to step ST520. If the calculation unit 112 determines that no noise is to be calculated, the process proceeds to step. ST540.

### (Step ST520)

After determining that noise is to be calculated, the calculation unit 112 calculates noise using the calculated partial gradient. The calculated partial gradient is, for example, a partial gradient calculated in the previous learning process (for example, the immediately preceding partial gradient). For example, the calculation unit 112 calculates noise by applying the above formula (15).

### (Step ST530)

After calculating the noise, the calculation unit 112 calculates a partial gradient of the partial data using a parameter to which the noise is added. For example, the calculation unit 112 calculates a partial gradient in the parameter to which the noise is added by applying the above formula (14). After step ST530, the process proceeds to step ST450.

### (Step ST540)

After determining that no noise is to be calculated, the calculation unit 112 calculates a partial gradient of the partial data using a parameter to which no noise is added. The processing of step ST540 is similar to the processing of step ST240 of FIG. 2. After step ST540, the process proceeds to step ST450.

The flow of series of steps of training the neural network in the second embodiment has been described above. Next, a specific process performed in one parameter update in a case where noise is added to a model coefficient in the second embodiment will be described.

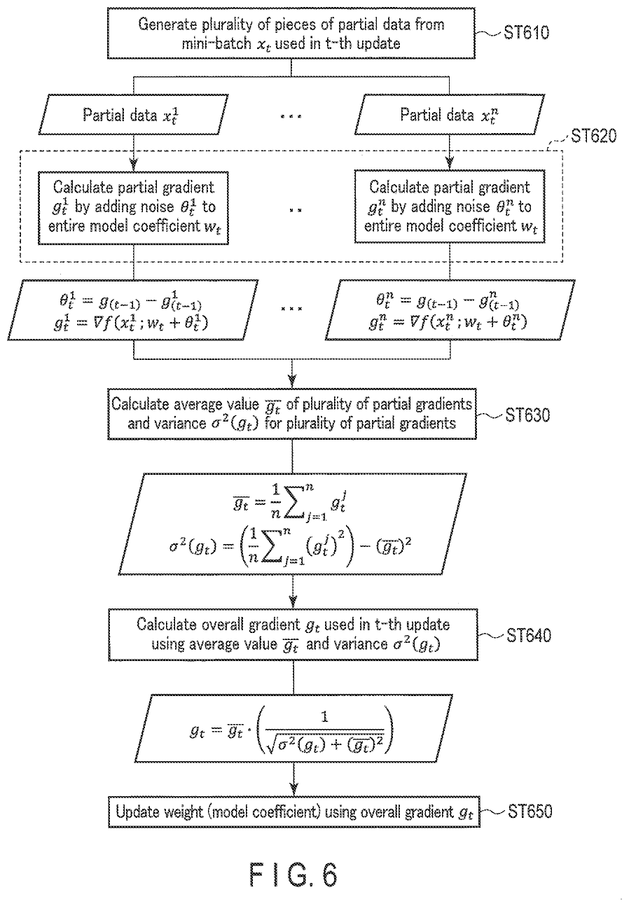

FIG. 6 is a flowchart illustrating a specific example of a parameter update process in the second embodiment. The flowchart of FIG. 6 relates to processing in step ST430, step ST520, step ST530, step ST450, and step ST460 in the flowchart of FIG. 4 and the flowchart of FIG. 5. Hereinafter, specific processing of a mini-batch xₜ used in the t-th update will be described.

### (Step ST610)

The generation unit 111 generates a plurality of pieces of partial data from the mini-batch xₜ used in the t-th update. In the case of dividing the mini-batch xₜ into n pieces of partial data, the generation unit 111 generates partial data xₜ¹ to partial data xₜⁿ.

### (Step ST620)

The calculation unit 112 calculates a partial gradient by adding noise to the entire model coefficient wₜ. For example, the calculation unit 112 calculates noise based on each partial gradient calculated in the immediately preceding learning process, and calculates partial gradients gₜ¹ to gₜⁿ corresponding to the partial data xₜ¹ to the partial data xₜⁿ taking the calculated noise into account. The noise θₜ¹ and the partial gradient gₜ¹ related to the partial data xₜ¹ are expressed by the following formulas (16) and (17), respectively. Furthermore, the noise θₜⁿ and the partial gradient gₜⁿ related to the partial data xₜⁿ are expressed by the following formulas (18) and (19), respectively.

θₜ¹=g₍ₜ₋₁₎−g₍ₜ₋₁₎¹ (16)

gₜ¹=∇f(xₜ¹;wₜ+θₜ¹) (17)

θₜⁿ=g₍ₜ₋₁₎−g₍ₜ₋₁₎ⁿ (18)

gₜⁿ=∇f(xₜⁿ;wₜ+θₜⁿ) (19)

### (Step ST630)

The calculation unit 112 calculates an average value gₜ of the plurality of partial gradients and a variance σ²(gₜ) for the plurality of partial gradients. The average value gₜ and the variance σ²(gₜ) are expressed by the above formulas (11) and (12), respectively.

### (Step ST640)

The calculation unit 112 calculates an overall gradient gₜ used in the t-th update using the average value gₜ and the variance σ² (gₜ). The overall gradient gₜ is expressed by the above formula (13).

### (Step ST650)

The update unit 113 updates the weight (model coefficient) using the overall gradient gₜ. For example, in the case of optimization by Momentum SGD, the update unit 113 updates the weight by applying the formulas (3) and (4) described above.

As described above, the learning apparatus according to the second embodiment generates a plurality of pieces of partial data from a mini-batch of learning data used for a plurality of learning processes for learning of a parameter of a neural network using an objective function, calculates a partial gradient that is a gradient related to the parameter of the objective function for each of the plurality of pieces of partial data, and updates the parameter based on an average value of the plurality of partial gradients corresponding to the plurality of pieces of partial data and a variance for the plurality of partial gradients. Furthermore, the learning apparatus calculates noise to be added to the parameter for each of the plurality of pieces of partial data, and calculates a partial gradient for the parameter to which the noise is added.

Therefore, since the learning apparatus according to the second embodiment can not only produce the advantageous effect according to the first embodiment but also add noise in an appropriate direction to the shape of the objective function, thereby achieving efficient smoothing in accordance with the objective function.

### Third Embodiment

It has been described that both the parameter update process in the first embodiment and the parameter update process in the second embodiment are executed by one learning apparatus. On the other hand, in relation to a third embodiment, a parameter update process executed by a plurality of learning apparatuses will be described.

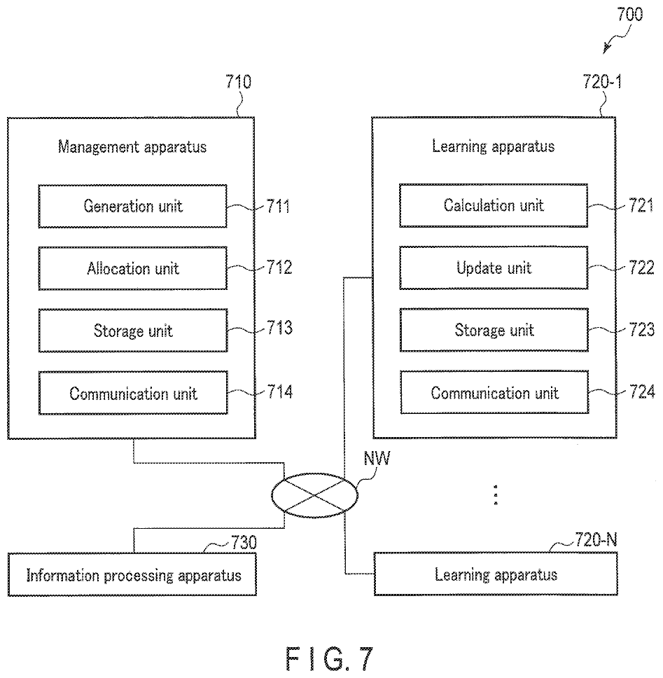

FIG. 7 is a block diagram illustrating a configuration example of an information processing system 700 including a management apparatus 710 and a plurality of learning apparatuses 720-1 to 720-N according to the third embodiment. The information processing system 700 illustrated in FIG. 7 includes the management apparatus 710, the plurality of learning apparatuses 720-1 to 720-N, and the information processing apparatus 730. These apparatuses are connected via, for example, a network NW. Any one of the management apparatus 710 and the plurality of learning apparatuses 720-1 to 720-N, and the information processing apparatus 730 may be realized by, for example, a server apparatus which is a computer including a processor such as a CPU. Each of the plurality of learning apparatuses 720-1 to 720-N may be referred to as a node. Since the information processing apparatus 730 is substantially similar to the information processing apparatus 120 illustrated in FIG. 1, the description thereof will be omitted.

The management apparatus 710 is an apparatus that integrally manages the plurality of learning apparatuses 720-1 to 720-N. The plurality of learning apparatuses 720-1 to 720-N are apparatuses that train a neural network. The information processing apparatus 730 is an apparatus that executes processing using a neural network trained by the plurality of learning apparatuses 720-1 to 720-N or the like.

The management apparatus 710 and the plurality of learning apparatuses 720-1 to 720-N may not be separate apparatuses. For example, any of the plurality of learning apparatuses 720-1 to 720-N may have the function of the management apparatus 710. Furthermore, any of the plurality of learning apparatuses 720-1 to 720-N and the information processing apparatus 730 may not be separate apparatuses. For example, any of the plurality of learning apparatuses 720-1 to 720-N may have the function of the information processing apparatus 730. Furthermore, the plurality of learning apparatuses 720-1 to 720-N or a combination of the management apparatus 710 and the plurality of learning apparatuses 720-1 to 720-N may be referred to as a learning system.

The management apparatus 710 includes a generation unit 711, an allocation unit 712, a storage unit 713 (memory), and a communication unit 714.

The generation unit 711 generates individual learning data used for learning of the neural network. Specifically, the generation unit 711 generates a plurality of mini-batches partially sampled from the learning data. The generation unit 711 also selects a mini-batch to be subjected to the learning process from the plurality of mini-batches, and generates a plurality of pieces of partial data from the selected mini-batch.

The allocation unit 712 allocates the plurality of pieces of partial data to the plurality of corresponding learning apparatuses 720-1 to 720-N.

The storage unit 713 stores various types of information used in various processes by the management apparatus 710. Specifically, the storage unit 713 stores parameters of the neural network to be learned, learning data used for learning of the neural network, and the like.

The communication unit 714 communicates with the plurality of learning apparatuses 720-1 to 720-N and the information processing apparatus 730 for various types of information by the management apparatus 710. Specifically, the communication unit 714 receives the learning data from the information processing apparatus 730. Furthermore, the communication unit 714 transmits (outputs) the plurality of pieces of partial data to the plurality of corresponding learning apparatuses 720-1 to 720-N. Furthermore, the communication unit 714 outputs the learned parameters of the neural network to the information processing apparatus 730.

The plurality of learning apparatuses 720-1 to 720-N dispersedly execute a partial gradient calculation process and the like for a plurality of pieces of partial data generated from one mini-batch. Since the plurality of learning apparatuses 720-1 to 720-N are similar in configuration, they are simply referred to as learning apparatuses 720 in a case where it is not necessary to distinguish between them. The number of learning apparatuses 720 is two or more, for example.

Each of the learning apparatuses 720 include a calculation unit 721, an update unit 722, a storage unit 723 (memory), and a communication unit 724.

The calculation unit 721 calculates various types of information used at the time of parameter learning in the neural network. Specifically, the calculation unit 721 calculates a gradient (partial gradient) related to the parameter of an objective function for each of the plurality of pieces of partial data. Furthermore, the calculation unit 721 may calculate noise to be added to the parameter. The calculation unit 721 may also calculate an average value of a plurality of partial gradients, a variance for the plurality of partial gradients, and an overall gradient. The average value of the plurality of partial gradients, the variance for the plurality of partial gradients, and the overall gradient may be calculated only by a specific learning apparatus.

The update unit 722 updates the parameters (weights) using the results of calculation by the calculation unit 721. Specifically, the update unit 722 updates the weight using the average value and the variance. More specifically, the update unit 722 updates the weight using the overall gradient calculated using the average value and the variance.

The storage unit 723 stores various types of information used in various processes by the learning apparatuses 720. Specifically, the storage unit 723 stores parameters of the neural network to be learned, learning data used for learning of the neural network, and the like.

The communication unit 724 communicates various types of information provided by the learning apparatuses 720 with the management apparatus 710, the information processing apparatus 730, and other learning apparatuses. Specifically, the communication unit 724 receives partial data from the management apparatus 710. The communication unit 724 also transmits (outputs) gradient information on parameter update to the other learning apparatuses. The gradient information on parameter update is, for example, information of a partial gradient, information of a square of a partial gradient, information of an average value of a plurality of partial gradients, and information of a variance for a partial gradient. Furthermore, the communication unit 724 outputs the learned parameters of the neural network to the information processing apparatus 730.

In summary, the management apparatus 710 and the learning apparatuses 720 include, by role, the units included in the learning apparatus 110 according to the first embodiment. That is, the management apparatus 710 generates partial data based on the learning data, and the learning apparatuses 720 calculate a partial gradient based on the partial data. A specific learning apparatus calculates the overall gradient based on the plurality of partial gradients.

The management apparatuses 710 and the learning apparatus 720 according to the third embodiment have been described above. Next, operations of the management apparatus 710 and one of the learning apparatuses 720 will be described with reference to FIGS. 2 and 4.

In the process in the flowchart of FIG. 2, the management apparatus 710 executes steps ST210 to ST230 and step ST270, and the learning apparatus 720 executes steps ST240 to ST260. In step ST270, the management apparatus 710 determines whether to end the learning.

A process in which the learning apparatus 720 receives partial data from the management apparatus 710 is included between steps ST230 and ST240. In addition, a process in which the learning apparatus 720 shares the information on the partial gradient and the information on the square of the partial gradient with the other learning apparatuses is included between steps ST250 and ST260. For this processing, for example, ring-type All-Reduce is used. The ring-type All-Reduce will be described later.

In the process in the flowchart of FIG. 4, the management apparatus 710 executes steps ST410 to ST430 and step ST470, and the learning apparatus 720 executes steps ST440 to ST460. In step ST470, the management apparatus 710 determines whether to end the learning.

A process in which the learning apparatus 720 receives partial data from the management apparatus 710 is included between steps ST430 and ST440. In addition, a process in which the learning apparatus 720 shares the information on the partial gradient and the information on the square of the partial gradient with the other learning apparatuses is included between steps ST450 and ST460.

The flow of series of steps of training the neural network in the third embodiment has been described above. Next, a specific process performed in one parameter update in a case where noise is added to a model coefficient of each node in the third embodiment will be described.

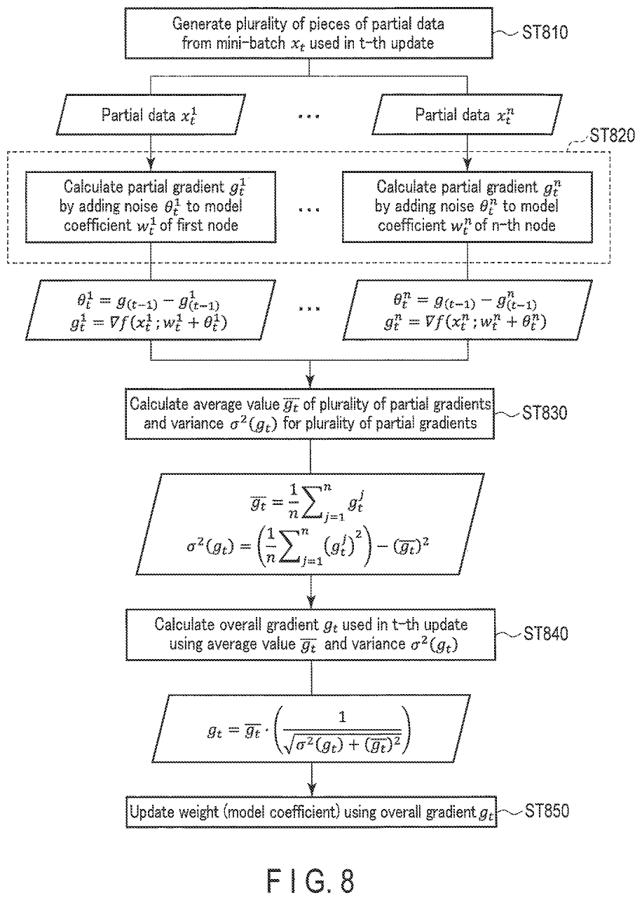

FIG. 8 is a flowchart illustrating a specific example of a parameter update process in the third embodiment. The flowchart of FIG. 8 relates to processing in step ST430, step ST520, step ST530, step ST450, and step ST460 in the flowchart of FIG. 4 and the flowchart of FIG. 5.

### (Step ST810)

The generation unit 711 of the management apparatus 710 generates a plurality of pieces of partial data from the mini-batch xₜ used in the t-th update. In the case of dividing the mini-batch xₜ into n pieces of partial data, the generation unit 711 generates partial data xₜ¹ to partial data xₜⁿ.

After step ST810, the management apparatus 710 allocates the plurality of pieces of partial data to the plurality of corresponding learning apparatuses. In relation to next step ST820, operations of the learning apparatus 720-1 (first node) and the learning apparatus 720-n (n-th node) among the plurality of learning apparatuses will be described. Note that the same operation is performed in the other learning apparatuses.

### (Step ST820)

The learning apparatus 720-1 calculates a partial gradient by adding noise to the model coefficient wₜ¹ allocated in advance. For example, the learning apparatus 720-1 calculates noise based on the partial gradient calculated in the immediately preceding learning process, and calculates the partial gradient gₜ¹ corresponding to the partial data xₜ¹ in consideration of the calculated noise. The noise gₜ¹ and the partial gradient gₜ¹ related to the partial data xₜ¹ are expressed by the following formulas (20) and (21), respectively.

θₜ¹=g₍ₜ₋₁₎−g₍ₜ₋₁₎¹ (20)

gₜ¹=∇f(xₜ¹;wₜ¹+θₜ¹) (21)

The learning apparatus 720-n calculates a partial gradient by adding noise to the model coefficient wₜⁿ allocated in advance. For example, the learning apparatus 720-n calculates noise based on the partial gradient calculated in the immediately preceding learning process, and calculates the partial gradient gₜⁿ corresponding to the partial data xₜⁿ in consideration of the calculated noise. The noise θₜⁿ and the partial gradient gₜⁿ related to the partial data xₜⁿ are expressed by the following formulas (22) and (23), respectively.

θₜⁿ=g₍ₜ₋₁₎−g₍ₜ₋₁₎ⁿ (22)

gₜⁿ=∇f(xₜⁿ;wₜⁿ+θₜⁿ) (23)

After step ST820, the plurality of learning apparatuses 720-1 to 720-n share the information of the partial gradients calculated by themselves. In next step ST830, operations of a specific learning apparatus (here, the learning apparatus 720-1) will be described.

### (Step ST830)

Based on the plurality of partial gradients from the other learning apparatuses, the learning apparatus 720-1 calculates an average value gₜ of the plurality of partial gradients and a variance σ²(gₜ) for the plurality of partial gradients. The average value gₜ and the variance σ²(gₜ) are expressed by the above formulas (11) and (12), respectively.

After step ST830, the information on the average value and the variance (gradient information) calculated by the learning apparatus 720-1 is shared by the other learning apparatuses. In next steps ST840 and ST850, operations of each of the learning apparatuses 720 will be described without distinguishing the learning apparatuses.

### (Step ST840)

The learning apparatus 720 calculates an overall gradient gₜ used in the t-th update using the average value gₜ and the variance σ²(gₜ). The overall gradient gₜ is expressed by the above formula (13).

### (Step ST850)

The learning apparatus 720 updates the weight (model coefficient) using the overall gradient gₜ. For example, in the case of optimization by Momentum SGD, the learning apparatus 720 updates the weight by applying the formulas (3) and (4) described above.

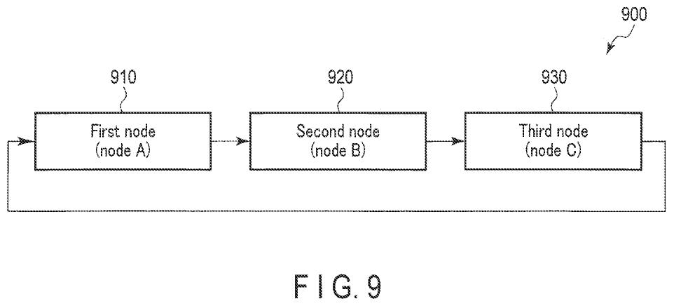

FIG. 9 is a diagram illustrating a ring All-Reduce communication pattern in the third embodiment. A communication pattern 900 in FIG. 9 illustrates a communication relationship among a first node 910 (node A), a second node 920 (node B), and a third node 930 (node C). Specifically, the node A sends data to the node B, the node B sends data to the node C, and the node C sends data to the node A. In the following description, it is assumed that an average value and a variance are calculated based on a plurality of partial gradients aggregated by the node A. The node A that calculates the average value and the variance may be called a specific learning apparatus.

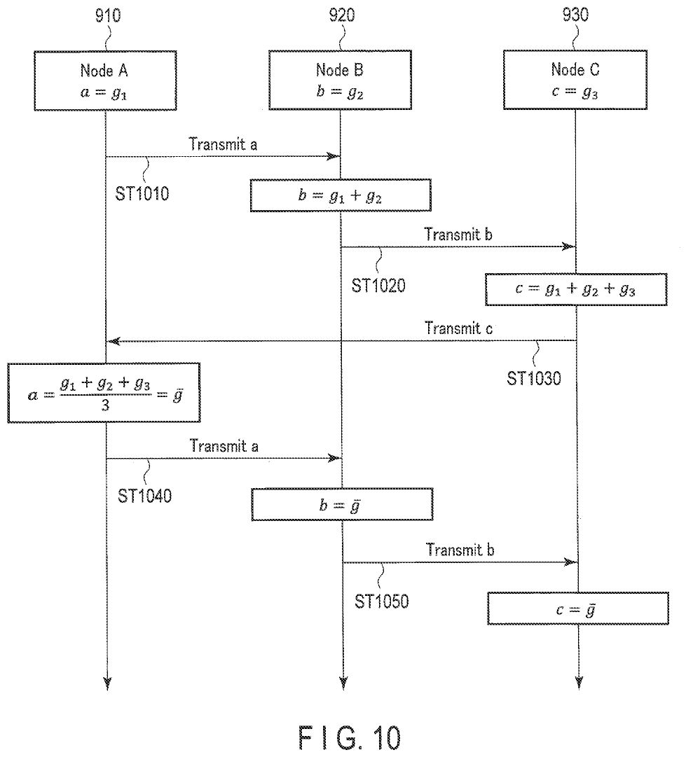

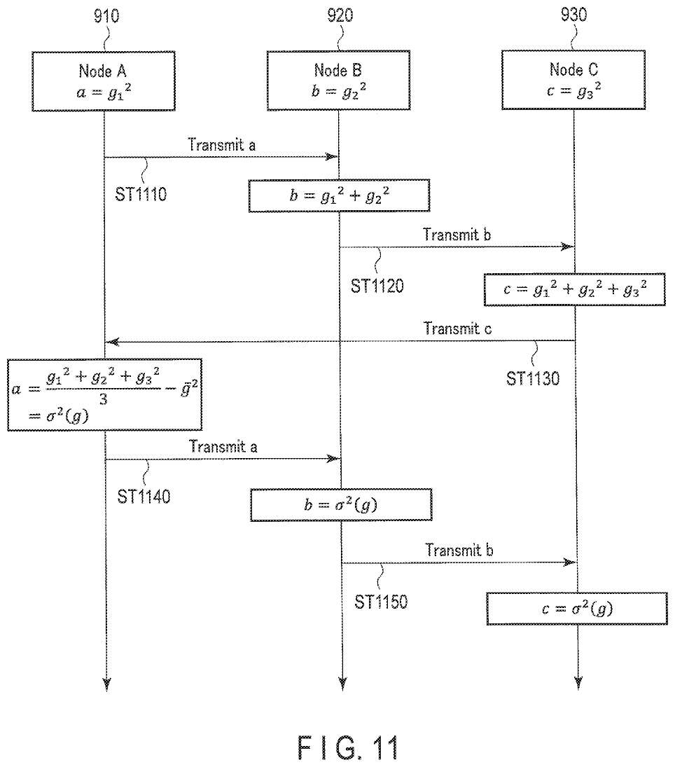

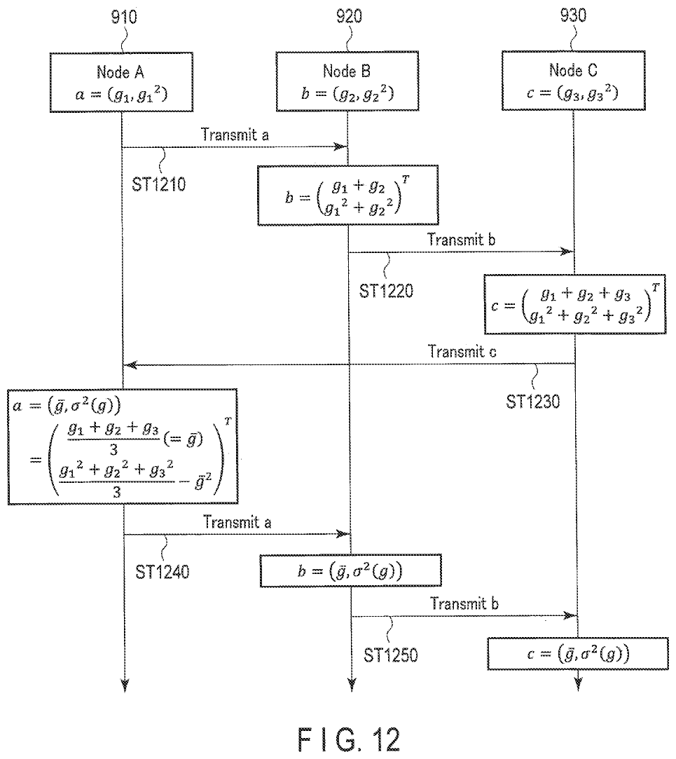

Hereinafter, two methods for information sharing between nodes will be described below. The first method is a method by which to transmit one piece of data by one data transmission. One data transmission is to transmit data from one node to another node. The second method is a method by which to transmit a plurality of pieces of data by one data transmission. The first method will be described with reference to FIGS. 10 and 11, and the second method will be described with reference to FIG. 12.

FIG. 10 is a diagram illustrating a specific example in which nodes share an average value of a plurality of partial gradients in the ring All-Reduce illustrated in FIG. 3. When each node calculates a partial gradient, each node holds the partial gradient. For example, the node A holds a partial gradient g₁ in data a, the node B holds a partial gradient g₂ in data b, and the node C holds a partial gradient g₃ in data c.

### (Step ST1010)

The node A transmits the data a (=g₁) to the node B. Upon receipt of the data a, the node B aggregates g₁ stored in the data a. Specifically, the node B adds g₁ to the data b and holds the data b.

### (Step ST1020)

The node B transmits the data b (=g₁+g₂) to the node C. Upon receipt of the data b, the node C aggregates g₁+g₂ stored in the data b. Specifically, the node C adds g₁+g₂ to the data c and holds the data c.

### (Step ST1030)

The node C transmits the data c (=g₁+g₂+g₃) to the node A. Upon receipt of the data c, the node A calculates and holds an average value g of g₁+g₂+g₃ stored in the data c. Specifically, the node A calculates an average value g of a plurality of partial gradients based on the aggregated partial gradients g₁+g₂+g₃ and the total number of nodes of 3, and holds the average value g in the data a.

### (Step ST1040)

The node A transmits the data a (=average value g) to the node B. Upon receipt of the data a, the node B holds the average value g in the data b.

### (Step ST1050)

The node B transmits the data b (=average value g) to the node C. Upon receipt of the data b, the node C holds the average value g in the data c. After the processing of step ST1050, the nodes share the average value g of the plurality of partial gradients.

FIG. 11 is a diagram illustrating a specific example in which the nodes share a variance of a plurality of partial gradients in the ring All-Reduce illustrated in FIG. 3. After the nodes share the average value g of the plurality of partial gradients, each node holds a square of the respective partial gradient (hereinafter called square data). For example, the node A holds the square data g₁² in the data a, the node B holds the square data g₂² in the data b, and the node C holds the square data g₃² in the data c.

### (Step ST1110)

The node A transmits the data a (=g₁²) to the node B. Upon receipt of the data a, the node B aggregates g₁² stored in the data a. Specifically, the node B adds g₁² to the data b and holds the data b.

### (Step ST1120)

The node B transmits the data b (=g₁²+g₂²) to the node C. Upon receipt of the data b, the node C aggregates g₁²+g₂² stored in the data b. Specifically, the node C adds g₁²+g₂² to the data c and holds the data c.

### (Step ST1130)

The node C transmits the data c (=g₁²+g₂²+g₃²) to the node A. Upon receipt of the data c, the node A calculates a variance σ²(g) for the plurality of partial gradients using g₁²+g₂²+g₃² stored in the data c and the already shared average value g, and holds the variance σ²(g) in the data a. The variance σ²(g) is expressed by, for example, the following formula (24).

$${σ}^{2} ( g ) = \frac{{g}_{1}^{2} + {g}_{2}^{2} + {g}_{3}^{2}}{3} - {\overline{g}}^{2} \qquad ( 24 )$$

### (Step ST1140)

The node A transmits the data a (=the variance σ²(g)) to the node B. Upon receipt of the data a, the node B holds the variance σ²(g) in the data b.

### (Step ST1150)

The node B transmits the data b (=the variance σ²(g)) to the node C. Upon receipt of the data b, the node C holds the variance σ²(g) in the data c. After the processing of step ST1150, the nodes share the variance σ²(g) of the plurality of partial gradients.

In summary, in the first method illustrated in FIGS. 10 and 11, the nodes (the plurality of learning apparatuses) share the information on the partial gradients and the information on the squares of the partial gradients at different timings. In the first method, while the communication cost is increased compared to the related art, the memory use amount can be the same as the related art.

FIG. 12 is a diagram illustrating a specific example in which the nodes simultaneously share an average value and a variance in the ring All-Reduce illustrated in FIG. 3. When each node calculates a partial gradient, each node holds the partial gradient and the square of the partial gradient (square data). For example, the node A holds (g₁, g₁²) in the data a, the node B holds (g₂, g₂²) in the data b, and the node C holds (g₃, g₃²) in the data c.

### (Step ST1210)

The node A transmits the data a (=(g₁, g₁²)) to the node B. Upon receipt of the data a, the node B aggregates (g₁, g₁²) stored in the data a by element. Specifically, the node B adds (g₁, g₁²) to the data b and holds the data b for each element.

### (Step ST1220)

The node B transmits the data b (=(g₁+g₂, g₁²+g₂²)) to the node C. Upon receipt of the data b, the node C aggregates (g₁+g₂, g₁²+g₂²) stored in the data b by element. Specifically, the node C adds (g₁+g₂, g₁²+g₂²) to the data c and holds the data c for each element.

### (Step ST1230)

The node C transmits the data c (g₁+g₂+g₃, g₁²+g₂²+g₃²)) to the node A. Upon receipt of the data c, the node A calculates an average value g of g₁+g₂+g₃ stored in the data c, and further calculates a variance σ²(g) for the plurality of partial gradients using g₁²+g₂²+g₃² stored in the data c and the already shared average value g, and holds the variance σ²(g) in the data a. The variance σ²(g) is expressed by, for example, the above formula (24).

### (Step ST1240)

The node A transmits the data a (=(average value g, variance σ²(g))) to the node B. Upon receipt of the data a, the node B holds (average value g, variance σ²(g)) in the data b.

### (Step ST1250)

The node B transmits the data b (=(average value g, variance σ²(g))) to the node C. Upon receipt of the data b, the node C holds (average value g, variance σ²(g)) in the data c. After the processing of step ST1250, the nodes share the average value g of the plurality of partial gradients and the variance σ²(g) of the plurality of partial gradients.

In summary, in the second method illustrated in FIG. 12, the nodes (the plurality of learning apparatuses) share the information on the partial gradients and the information on the squares of the partial gradients at the same timing. In the second method, while the memory use amount is increased compared to the related art, the communication cost can be the same as the related art.

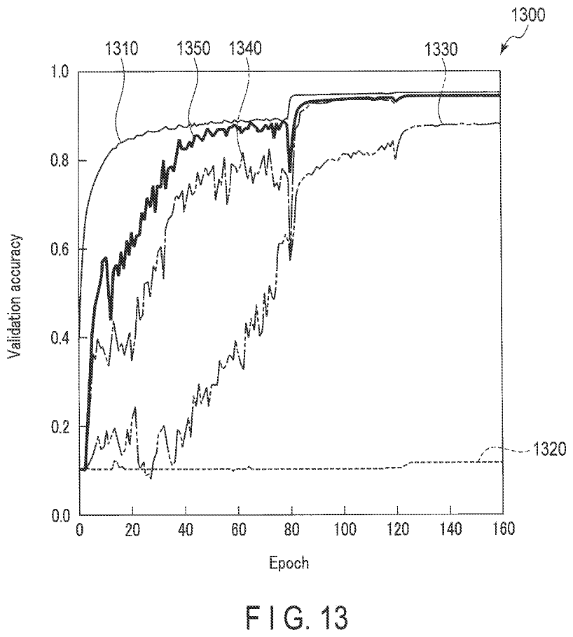

FIG. 13 illustrates evaluation results including learning curves using the parameter update processes in the first embodiment to the third embodiment. Evaluation results 1300 in FIG. 13 are obtained by constructing 32-layer ResNet (Residual Networks) and verifying the construction with the use of a CIFAR-10 data set as a benchmark. In addition, the evaluation results 1300 include five learning curves 1310 to 1350 verified under different conditions of the batch size and the optimization method.

The learning curve 1310 is a result of optimization by Momentum SGD using a conventional overall gradient (see the formula (6)) with a batch size of 128. The prediction accuracy in the learning curve 1310 is 94.7%.

The learning curve 1320 is a result of optimization by Momentum SGD using the conventional overall gradient with a batch size of 8192 (8 k). The prediction accuracy in the learning curve 1320 is 10.3%.

The learning curve 1330 is a result of optimization by Momentum SGD using the conventional overall gradient with a partial gradient calculated by adding noise to a parameter, with a batch size of 8 k. The prediction accuracy in the learning curve 1330 is 87.8%.

The learning curve 1340 is a result of optimization by Momentum SGD using the overall gradient (see the formula (8)) of the first embodiment with a batch size of 8 k. The prediction accuracy in the learning curve 1340 is 93.7%.

The learning curve 1350 is a result of optimization by Momentum SGD using the overall gradient of the second embodiment (or the third embodiment) (that is, the overall gradient of the first embodiment with the partial gradient calculated by adding noise to the parameter) with a batch size of 8 k. The prediction accuracy in the learning curve 1350 is 94.1%.

Therefore, it can be seen that the prediction accuracies of the learning curve 1340 and the learning curve 1350 are significantly higher than the prediction accuracy of the learning curve 1320. Thus, using any one of the methods of the above embodiments allows the prediction accuracy to be greatly improved as compared with the conventional method in which the batch size is simply increased.

As described above, the learning system according to the third embodiment includes a plurality of learning apparatuses that implements learning of parameters of a neural network by using an objective function, and a management apparatus that manages the plurality of learning apparatuses. The management apparatus generates a plurality of pieces of partial data from a mini-batch of learning data used for a plurality of learning processes for learning of the parameters, and allocates the plurality of pieces of partial data to the plurality of corresponding learning apparatuses. Each of the plurality of learning apparatuses calculates a partial gradient that is a gradient related to the parameter of the objective function for the allocated partial data, and updates the parameter based on an average value of the plurality of partial gradients corresponding to the plurality of pieces of partial data and a variance of the plurality of partial gradients.

Therefore, the learning system according to the third embodiment can implement efficient learning similarly to the first embodiment.

### Fourth Embodiment

In the parameter update processes in the first to third embodiments, the weight is updated using an average value and a variance. On the other hand, in a fourth embodiment, updating the weight with an average value and a moving average of a variance will be described. The following description is based on the assumption that the present invention is applied to the information processing system 700 illustrated in FIG. 7, but the present invention is not limited thereto.

Calculation units 721 of learning apparatuses 720 according to the fourth embodiment may further calculate the moving average of the variance. The moving average of the variance may be calculated only by a specific learning apparatus.

Specifically, each of the calculation units 721 calculates the moving average of the variance by using a history of variances of a plurality of partial gradients at the time of immediately preceding parameter update. Moving average uₜ of the variance is expressed by the following formula (25).

uₜ=β₂·uₜ₋₁+(1−β₂)·σ²(gₜ) (25)

In the formula (25), β₂ represents a coefficient for controlling the moving average. The coefficient for controlling the moving average is, for example, a value from 0 to 1. The coefficient for controlling the moving average is a coefficient that causes the moving average uₜ of the variance to more increasingly refer to a past history uₜ₋₁ as the value is closer to 1, and causes the moving average uₜ of the variance to less increasingly refer to (not consider) the past history uₜ₋₁ as the value is closer to 0. In the following embodiments, β₂=0.9 is set. When t=0, it is assumed that the moving average uₜ=0.

Furthermore, the calculation unit 721 calculates the overall gradient using the average value and the moving average of the variance. The overall gradient gt of the fourth embodiment using the average value and the moving average of the variance is expressed by the following formula (26).

$${g}_{t} = \overline{{g}_{t}} \cdot ( \frac{1}{\sqrt{{u}_{t} + {( \overline{{g}_{t}} )}^{2}}} ) \qquad ( 26 )$$

In other words, in the formula (26), the overall gradient is calculated by the product of the reciprocal of square root of sum of square of the average value and the moving average of the variance and the average value.

A flow of training the neural network is substantially similar to the flowchart of FIG. 4, and thus description thereof will be omitted. The fourth embodiment is different in that the update unit updates the weight using the average value and the moving average of the variance in step ST460 of the flowchart in FIG. 4. Hereinafter, an example will be described in which partial gradients are calculated with parameters to which no noise is added by using a plurality of learning apparatuses.

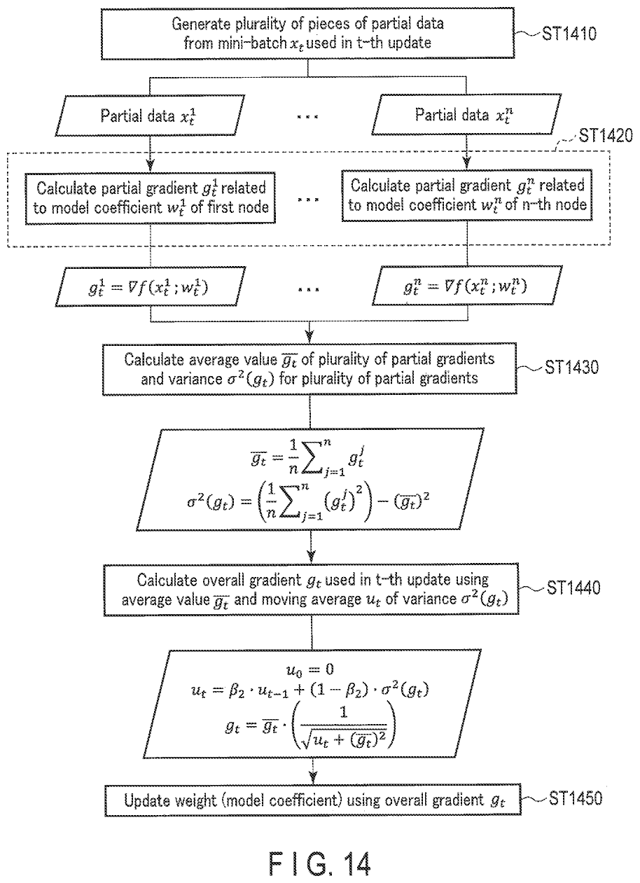

FIG. 14 is a flowchart illustrating a specific example of a parameter update process in the fourth embodiment. The flowchart of FIG. 14 relates to processing in step ST430, step ST520, step ST530, step ST450, and step ST460 in the flowchart of FIG. 4 and the flowchart of FIG. 5. However, the processing of step ST460 has the above-described difference.

### (Step ST1410)

The generation unit 711 of the management apparatus 710 generates a plurality of pieces of partial data from the mini-batch xₜ used in the t-th update. In the case of dividing the mini-batch xₜ into n pieces of partial data, the generation unit 711 generates partial data xₜ¹ to partial data xₜⁿ.

After step ST1410, the management apparatus 710 allocates the plurality of pieces of partial data to the plurality of corresponding learning apparatuses. In relation to next step ST1420, operations of the learning apparatus 720-1 (first node) and the learning apparatus 720-n (n-th node) among the plurality of learning apparatuses will be described. Note that the same operation is performed in the other learning apparatuses.

### (Step ST1420)

The learning apparatus 720-1 calculates a partial gradient related to the model coefficient wₜ¹ allocated in advance. For example, the learning apparatus 720-1 calculates the partial gradient gₜ¹ corresponding to the partial data xₜ¹. The partial gradient gₜ¹ is expressed by the following formula (27).

gₜ¹=∇f(xₜ¹;wₜ¹) (27)

The learning apparatus 720-n calculates a partial gradient related to the model coefficient wₜⁿ allocated in advance. For example, the learning apparatus 720-n calculates the partial gradient gₜⁿ corresponding to the partial data xₜⁿ. The partial gradient gₜⁿ is expressed by the following formula (28).

gₜⁿ=∇f(xₜⁿ;wₜⁿ) (28)

After step ST1420, the plurality of learning apparatuses 720-1 to 720-n share the information of the partial gradients calculated by themselves. In next step ST1430, operations of a specific learning apparatus (here, the learning apparatus 720-1) will be described.

### (Step ST1430)

Based on the plurality of partial gradients from the other learning apparatuses, the learning apparatus 720-1 calculates an average value gₜ of the plurality of partial gradients and a variance σ²(gₜ) for the plurality of partial gradients. The average value gₜ and the variance σ²(gₜ) are expressed by the above formulas (11) and (12), respectively.

After step ST1430, the information on the average value and the variance (gradient information) calculated by the learning apparatus 720-1 is shared by the other learning apparatuses. In next steps ST1440 and ST1450, operations of each of the learning apparatuses 720 will be described without distinguishing the learning apparatuses.

### (Step ST1440)

The learning apparatus 720 calculates an overall gradient gₜ used in the t-th update using the average value gₜ and the moving average uₜ of the variance σ²(gₜ). The moving average uₜ and the overall gradient gₜ are expressed by the above-described formulas (25) and (26).

### (Step ST1450)

The learning apparatus 720 updates the weight (model coefficient) using the overall gradient gₜ. For example, in the case of optimization by Momentum SGD, the learning apparatus 720 updates the weight by applying the formulas (3) and (4) described above.

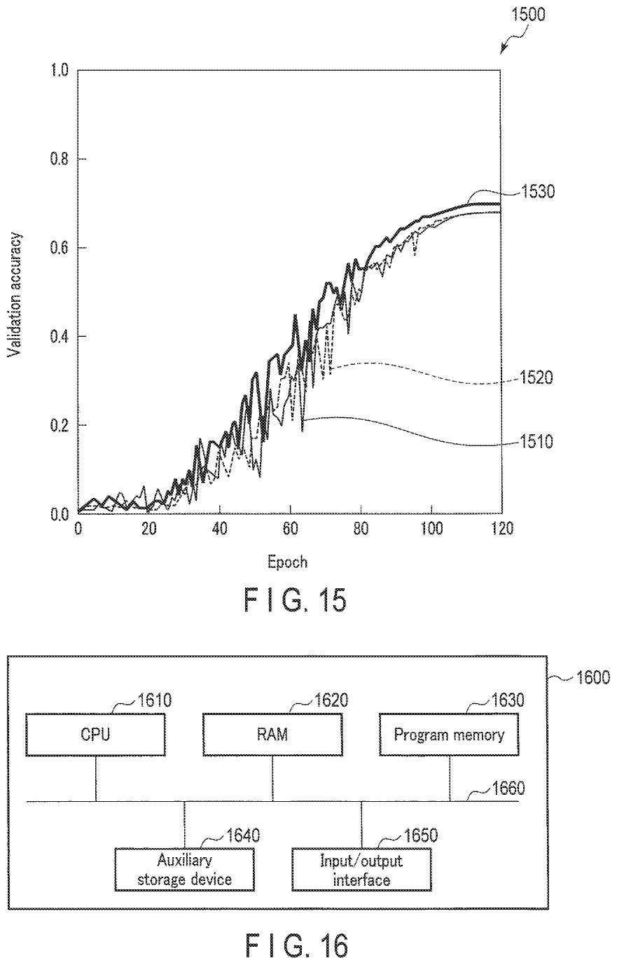

FIG. 15 illustrates evaluation results including learning curves using the parameter update process in the fourth embodiment. Evaluation results 1500 in FIG. 15 are obtained by constructing 50-layer ResNet and verifying the construction with the use of an ImageNet-1 k data set as a benchmark. In addition, the evaluation results 1500 include three learning curves 1510 to 1530 verified under different conditions of the optimization method. The batch size was 131 k under all conditions.

The learning curve 1510 is a result of optimization by Momentum SGD using a conventional overall gradient (see the formula (6)). The prediction accuracy in the learning curve 1510 is 67.7%.

The learning curve 1520 is a result of optimization by Momentum SGD using the overall gradient (see the formula (8)) of the first embodiment. The prediction accuracy of the learning curve 1520 is substantially similar to the prediction accuracy of the learning curve 1510.

The learning curve 1530 is a result of optimization by Momentum SGD using the overall gradient (see the formula (26)) of the fourth embodiment. The prediction accuracy in the learning curve 1530 is 69.4%.

Therefore, it can be seen that the prediction accuracy of the learning curve 1530 is higher than the prediction accuracy of the learning curve 1510. Therefore, using the method of the fourth embodiment improves the prediction accuracy as compared with the conventional method.

As described above, a learning system according to the fourth embodiment generates a plurality of pieces of partial data from a mini-batch of learning data used for a plurality of learning processes for learning a parameter of a neural network using an objective function, calculates a partial gradient that is a gradient related to the parameter of the objective function for each of the plurality of pieces of partial data, and updates the parameter based on an average value of the plurality of partial gradients corresponding to the plurality of pieces of partial data and a variance for the plurality of partial gradients. The learning apparatus also calculates the overall gradient that is a gradient of the objective function related to the mini-batch by using the average value and the variance, and updates the parameter based on the overall gradient. Furthermore, the learning apparatus calculates the overall gradient by the product of the reciprocal of square root of sum of square of the average value and the moving average of the variance and the average value.

Therefore, the learning system according to the fourth embodiment can implement efficient learning similarly to the first embodiment.

### (Hardware Configuration)

FIG. 16 is a block diagram illustrating a hardware configuration of a computer according to an embodiment. The computer 1600 includes, as hardware, a central processing unit (CPU) 1610, a random access memory (RAM) 1620, a program memory 1630, an auxiliary storage apparatus 1640, and an input/output interface 1650. The CPU 1610 communicates with the RAM 1620, the program memory 1630, the auxiliary storage apparatus 1640, and the input/output interface 1650 via the bus 1660.

The CPU 1610 is an example of a general-purpose processor. The RAM 1620 is used as a working memory by the CPU 1610. The RAM 1620 includes a volatile memory such as a synchronous dynamic random access memory (SDRAM). The program memory 1630 stores various programs including a parameter update processing program and the like. Used as the program memory 1630 is, for example, a read-only memory (ROM), a part of the auxiliary storage apparatus 1640, or a combination thereof. The auxiliary storage apparatus 1640 stores data non-temporarily. The auxiliary storage apparatus 1640 includes a non-volatile memory such as an HDD or an SSD.

The input/output interface 1650 is an interface for connecting to other devices. The input/output interface 1650 is used, for example, for connection with a sound collecting device and an output apparatus.

Each program stored in the program memory 1630 includes a computer-executable instruction. When executed by the CPU 1610, the program (computer-executable instruction) causes the CPU 1610 to execute predetermined processing. For example, when executed by the CPU 1610, the parameter update processing program or the like causes the CPU 1610 to execute a series of processes described in relation to the components illustrated FIGS. 1 and 7.

The program may be provided to the computer 1600 in a state of being stored in a computer-readable storage medium. In this case, for example, the computer 1600 further includes a drive (not illustrated) that reads data from the storage medium, and acquires the program from the storage medium. Examples of the storage medium include a magnetic disk, an optical disk (CD-ROM, CD-R, DVD-ROM, DVD-R, or the like), a magneto-optical disk (MO or the like), and a semiconductor memory. The program may be stored in a server on a communication network, and the computer 1600 may download the program from the server using the input/output interface 1650.

The processing described in relation to the embodiment may not be performed by a general-purpose hardware processor such as the CPU 1610 executing a program, but may be performed by a dedicated hardware processor such as an application specific integrated circuit (ASIC). The term processing circuit (processing unit) includes at least one general-purpose hardware processor, at least one special-purpose hardware processor, or a combination of at least one general-purpose hardware processor and at least one special-purpose hardware processor. In the example illustrated in FIG. 16, the CPU 1610, the RAM 1620, and the program memory 1630 correspond to a processing circuit.

Therefore, according to each of the above embodiments, it is possible to implement efficient learning.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning apparatus comprising processing circuitry configured to:
generate a plurality of pieces of partial data from a mini-batch of learning data used for a plurality of learning processes for learning of a parameter of a neural network using an objective function;
calculate a partial gradient that is a gradient related to the parameter of the objective function for each of the pieces of partial data; and
update the parameter based on an average value of the plurality of partial gradients corresponding to the pieces of partial data and a variance for the partial gradients.

2. The learning apparatus according to claim 1, wherein the processing circuitry is further configured to:
calculate an overall gradient that is a gradient of the objective function for the mini-batch by using the average value and the variance; and
update the parameter based on the overall gradient.

3. The learning apparatus according to claim 2, wherein the processing circuitry is further configured to calculate the overall gradient by a product of the average value and a reciprocal of a square root of a sum of a square of the average value and the variance.

4. The learning apparatus according to claim 2, wherein the processing circuitry is further configured to calculate the overall gradient by a product of the average value and a reciprocal of a square root of a sum of a square of the average value and a moving average of the variance.

5. The learning apparatus according to claim 1, wherein the processing circuitry is further configured to calculate noise to be added to the parameter for each of the pieces of partial data, and calculate the partial gradient for the parameter to which the noise is added.

6. The learning apparatus according to claim 5, wherein the processing circuitry is further configured to calculate the noise by using a difference between an immediately preceding overall gradient calculated by immediately preceding parameter update and an immediately preceding partial gradient of each of a pieces of immediately preceding partial data used at the time of the immediately preceding parameter update.

7. A learning system comprising:
a plurality of learning apparatuses that learns parameters of a neural network by using an objective function; and
a management apparatus that manages the learning apparatuses,
wherein the management apparatus
generates a plurality of pieces of partial data from a mini-batch of learning data used for a plurality of learning processes for learning of the parameters and
allocates the pieces of partial data to the corresponding learning apparatuses,
each of the learning apparatuses
calculates a partial gradient that is a gradient related to the parameter of the objective function for the allocated partial data, and
updates the parameter based on an average value of a plurality of partial gradients corresponding to the pieces of partial data and a variance of the partial gradients.

8. The learning system according to claim 7, wherein the learning apparatuses share gradient information on update of the parameter by communicating with each other.

9. The learning system according to claim 8, wherein the gradient information includes information of the partial gradient.

10. The learning system according to claim 9, wherein
each of the learning apparatuses calculates a square of the partial gradient, and
the gradient information further includes information of the square of the partial gradient.

11. The learning system according to claim 10, wherein the learning apparatuses shares the information of the partial gradient and the information of the square of the partial gradient at different timings.

12. The learning system according to claim 10, wherein the learning apparatuses shares the information of the partial gradient and the information of the square of the partial gradient at the same timing.

13. The learning system according to claim 7, wherein
a specific learning apparatus among the learning apparatuses calculates an overall gradient that is a gradient of the objective function related to the mini-batch by using the average value and the variance, and
each of the learning apparatuses updates the parameter based on the overall gradient.

14. The learning system according to claim 13, wherein the specific learning apparatus calculates the overall gradient by a product of the average value and a reciprocal of a square root of a sum of a square of the average value and the variance.

15. The learning system according to claim 13, wherein the specific learning apparatus calculates the overall gradient by a product of the average value and a reciprocal of a square root of a sum of a square of the average value and a moving average of the variance.

16. The learning system according to claim 7, wherein each of the learning apparatuses calculates noise to be added to the parameter for the allocated partial data, and calculates the partial gradient for the parameter to which the noise is added.

17. The learning system according to claim 16, wherein each of the learning apparatuses calculates the noise by using a difference between an immediately preceding overall gradient calculated by immediately preceding parameter update and an immediately preceding partial gradient of immediately preceding partial data used at the time of the immediately preceding parameter update.

18. A learning method comprising:
generating a plurality of pieces of partial data from a mini-batch of learning data used for a plurality of learning processes for learning of a parameter of a neural network using an objective function;
calculating a partial gradient that is a gradient related to the parameter of the objective function for each of the pieces of partial data; and
updating the parameter based on an average value of the plurality of partial gradients corresponding to the pieces of partial data and a variance for the partial gradients.
